(19) United States
(12) Patent Application Publication
(10) Pub. No.: US 2025/0224531 A1
(43) Pub. Date: Jul. 10, 2025

(54) SYSTEMS AND METHOD OF PARALLEL CROSS-SPREAD SORTING FOR SEISMIC DATA

(71) Applicant: SAUDI ARABIAN OIL COMPANY, Dhahran (SA)

(72) Inventors: Yi He, Beijing (CN); Yujin Liu, Beijing (CN); Hongwei Liu, Dhahran (SA); Fuhao Qin, Dhahran (SA); Yue Du, Beijing (CN)

(73) Assignees: ARAMCO FAR EAST (BEIJING) BUSINESS SERVICES CO., LTD., Beijing (CN); SAUDI ARABIAN OIL COMPANY, Dhahran (SA)

(21) Appl. No.: 18/700,239

(22) PCT Filed: Jan. 9, 2023
(86) PCT No.: PCT/CN2023/071241

§ 371 Date: Apr. 10, 2024

(51) Int. Cl. G01V 1/32; G01V 1/24

(52) U.S. Cl. CPC G01V 1/32; G01V 1/247

(57) ABSTRACT

Systems and methods for parallel sorting of seismic data are disclosed. The methods include obtaining a seismic dataset comprising a plurality of shot gathers; dividing headers from the plurality of shot gathers among a plurality of computer nodes; sorting the headers separately on each of the plurality of computer nodes; saving the sorted headers from the plurality of computer nodes to a temporary file; sorting the sorted headers saved to the temporary file into a cross spread gather ordering; and sorting seismic traces according to the cross spread gather ordering to create cross spread gathers. The methods further include applying a seismic imaging algorithm to the cross spread gathers to create a seismic image.

### BACKGROUND

Seismic records consist of the headers and the traces. Headers contain metadata related to the geographic location, number of data samples, sampling frequency, etc. The traces are the values of geophone displacement or velocity for a particular seismic shot and receiver combination. Different seismic processing methods operate on different combinations of seismic traces to produce an image of the subsurface. Furthermore, seismic data sets may comprise terabytes of data. Therefore, methods for quickly resorting traces can decrease processing time and thereby save money and allow for quicker decisions by managers.

Depending on the needs, different sorting algorithms are optimal for different applications. Multi-node parallel processing with the message passing interface (MPI) library, along with multithread algorithms offer a means to increase efficiency of these algorithms. The combination of sorting algorithms and parallel processing has not yet been applied to cross spread sorting for data preparation and offers a means to improve performance of seismic imaging algorithms, such as Kirchhoff migration.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments related to methods for parallel sorting of seismic data are disclosed. The methods include obtaining a seismic dataset comprising a plurality of shot gathers; dividing headers from the plurality of shot gathers among a plurality of computer nodes; sorting the headers separately on each of the plurality of computer nodes; saving the sorted headers from the plurality of computer nodes to a temporary file; sorting the sorted headers saved to the temporary file into a cross spread gather ordering; and sorting seismic traces according to the cross spread gather ordering to create cross spread gathers. The methods further include applying a seismic imaging algorithm to the cross spread gathers to create a seismic image.

In general, in one aspect, embodiments related to a non-transitory computer-readable memory including computer-executable instructions stored thereon are disclosed that, when executed on a processor, cause the processor to perform the steps of obtaining a seismic dataset comprising a plurality of shot gathers; dividing headers from the plurality of shot gathers among a plurality of computer nodes; sorting the headers separately on each of the plurality of computer nodes; saving the sorted headers from the plurality of computer nodes to a temporary file; sorting the sorted headers saved to the temporary file into a cross spread gather ordering; and sorting seismic traces according to the cross spread gather ordering to create cross spread gathers. The non-transitory computer-readable memory further cause the processor to perform the steps of applying a seismic imaging algorithm to the cross spread gathers to create a seismic image.

In general, in one aspect, embodiments are disclosed related to a system including a parallel processing computer system configured to divide headers from the plurality of shot gathers among a plurality of computer nodes; sort the headers separately on each of the plurality of computer nodes; save the sorted headers from the plurality of computer nodes to a temporary file; sort the sorted headers saved to the temporary file into a cross spread gather ordering; and sort seismic traces according to the cross spread gather ordering to create cross spread gathers. The parallel processing computer system is further configured to apply a seismic imaging algorithm to the cross spread gathers to create a seismic image.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1A shows seismic acquisition geometry and subsurface propagation of waves according to one or more embodiments.

FIG. 1B shows a cross-spread gather on the orthogonal acquisition geometry of 3D seismic acquisition according to one or more embodiments.

FIG. 1C shows isochrons of travel times, according to one or more embodiments.

FIG. 2A shows a procedure for loading data onto buffers, bucket sorting the data, and then writing the sorted data to a temporary file, according to one or more embodiments.

FIG. 2B shows the procedure for merge sorting several temporary files, according to one or more embodiments.

FIG. 2C shows a the process of dividing seismic data onto computer nodes and the location of bucket sorting and merge sorting algorithms in the procedure, according to one or more embodiments.

FIG. 3 shows the process of dividing seismic data onto computer nodes, according to one or more embodiments.

FIG. 4A shows seismic gathers before cross spread sorting, according to one or more embodiments.

FIG. 4B shows seismic gathers after cross spread sorting, according to one or more embodiments.

FIG. 4C shows a seismic image, a drilling rig, and a borehole path, according to one or more embodiments.

FIG. 5 shows the performance of the method of this invention versus number of nodes, according to one or more embodiments.

FIG. 6 shows a workflow for sorting seismic data, according to one or more embodiments.

FIG. 7 shows a computer system, according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

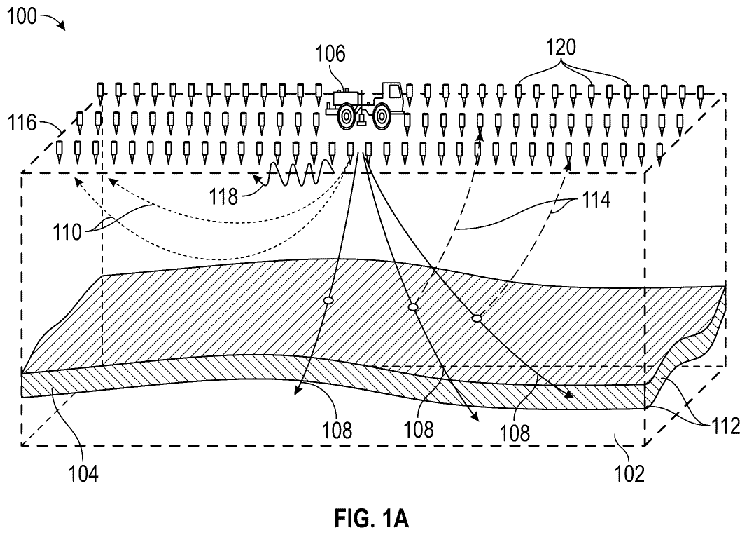

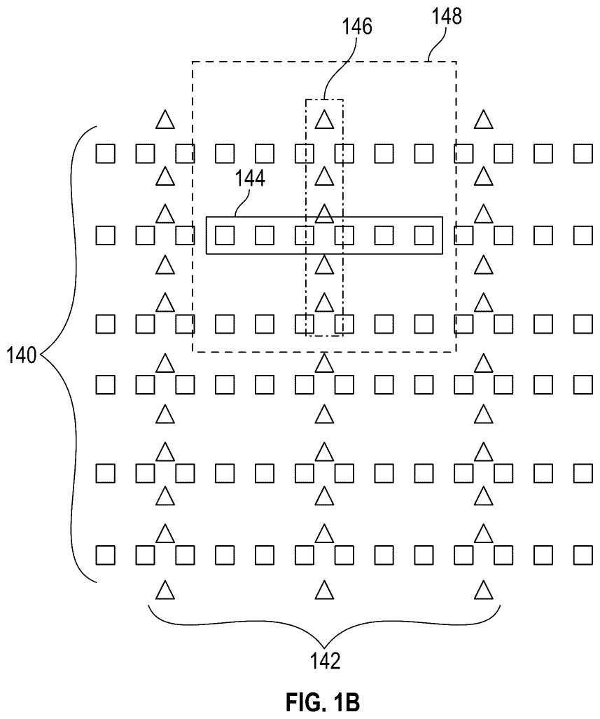

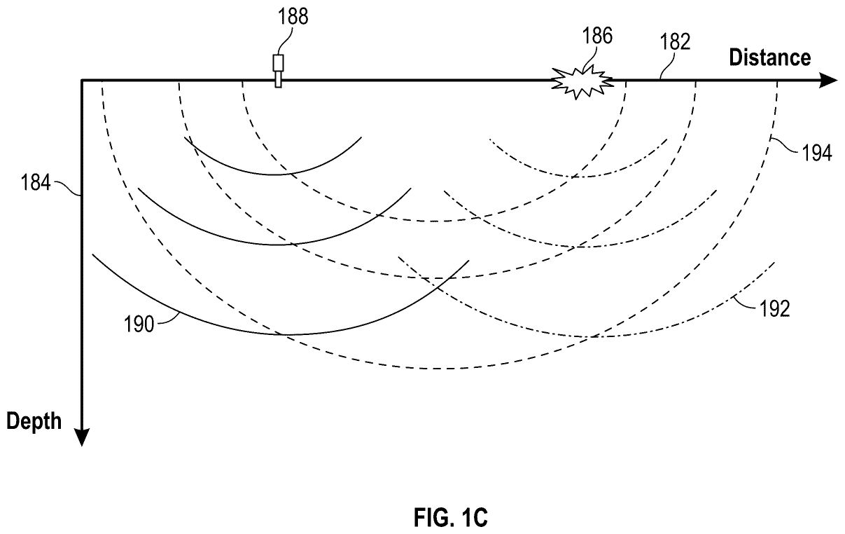

In the following description of FIGS. 1-7, any component described with regard to a figure, in various embodiments disclosed herein, may be equivalent to one or more like-named components described with regard to any other figure. For brevity, descriptions of these components may not be repeated for each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In one aspect, embodiments disclosed herein relate to systems and a method of parallel cross spread sorting for seismic data. The data sorting makes use of merge sort and bucket sort algorithms, as well as parallel computing and multi-threading. The one or more embodiments disclosed herein advantageously provide a method and systems for faster sorting of seismic data into cross spread gathers which, in turn, speeds up the process of producing a seismic image.

The traditional method for obtaining a seismic image begins with the design of the seismic data acquisition experiment. This includes selection of the type of seismic source used to send waves into the subsurface, the number of sources used, the location of seismic receivers used for each shot, as well as in-field filtering or removal of noisy traces. The geometric relationship of sources and receivers may be influenced by an intended target-perhaps known from another seismic experiment or from well data. To simplify processing, the seismic receivers are often laid out on an orthogonal grid; the sources are placed at points along the same grid. The traces are usually stored according to the shot number, i.e., for each shot, a contiguous portion of memory stores the data recorded by the receivers in some natural ordering, along with headers containing metadata. Seismic data stored in this way are known as a shot gather. Common header information for each seismic trace includes, among other data, the x and y coordinates of both the shots and the receivers.

Once recorded, the seismic data from the field are usually transported to a central processing location that has computational resources to convert them into an image of the subsurface. At this point, the processing workflow often begins with a sorting of the traces. An appropriate sorting can improve the performance of seismic data processing algorithms. One common sorting of seismic data is known as the common midpoint gather (CMP), where seismic traces are grouped together according to a shared midpoint between the shots and receivers. Using 3-D geometric considerations, nonlinear events appearing in CMP gathers can be stacked (i.e., summed) to produce a single trace that delineates geologic structures below each particular midpoint location.

FIG. 1A shows a seismic survey (100) of a subterranean region of interest (102), which may contain a hydrocarbon reservoir (104). In some cases, the subterranean region of interest (102) may lie beneath a lake, sea, or ocean. In other cases, the subterranean region of interest (102) may lie beneath an area of dry land. The seismic survey (100) may utilize a seismic source (106) that generates radiated seismic waves (108). The type of seismic source (106) may depend on the environment in which it is used, for example on land the seismic source (106) may be a vibroseis truck or an explosive charge, but in water the seismic source (106) may be an airgun. The radiated seismic waves (108) may return to the surface of the Earth (116) as refracted seismic waves (110) or may be reflected by geological discontinuities (112) and return to the surface as reflected seismic waves (114). The radiated seismic waves (108) may propagate along the surface as Rayleigh waves or Love waves, collectively known as “ground-roll” (118). Vibrations associated with ground-roll (118) do not penetrate far beneath the surface of Earth (116) and hence are not influenced, nor contain information about, portions of the subterranean region of interest (102) where hydrocarbon reservoirs (104) are typically located. Seismic receivers (120), located on or near the surface of Earth (116), detect reflected seismic waves (114), refracted seismic waves (110) and ground-roll (118).

In accordance with one or more embodiments, the refracted seismic waves (110), reflected seismic waves (114), and ground-roll (118) generated by a single activation of the seismic source (106) are recorded by a seismic receiver (120) as a time-series representing the amplitude of ground-motion at a sequence of discreet sample times. Usually the origin of the time-series, denoted t=0, is determined by the activation time of the seismic source (106). This time-series may be denoted a seismic “trace.” The seismic receivers (120) are positioned at a plurality of seismic receiver locations which we may denote (xᵣ,yᵣ) where x and y represent orthogonal axes on the surface of Earth (116) above the subterranean region of interest (102). Thus, the plurality of seismic traces generated by activations of the seismic source (106) at a single location may be represented as a three-dimensional “3D” volume with axes (xᵣ,yᵣ,t) where (xᵣ,yᵣ) represents the location of the seismic receiver (120) and t denotes the time sample at which the amplitude of ground-motion was measured.

However, a seismic survey (100) may include recordings of seismic waves generated by a seismic source (106) sequentially activated at a plurality of source locations denoted (xₛ,yₛ). In some cases, this may be achieved using a single seismic source (106) that is moved to a new location between activations. In other cases, a plurality of seismic sources (106) positioned at different locations may be used simultaneously. Irrespective of how they are acquired, all the seismic traces acquired by a seismic survey (100) may be represented as a five-dimensional volume, with coordinate axes (xₛ,yₛ,xᵣ,yᵣ,t), and called a “seismic dataset.”

FIG. 1B shows a cross-spread acquisition geometry in accordance with one or more embodiments. The cross-spread geometry includes a plurality of source locations on each of a plurality of source lines (140) and a plurality of receiver locations on each of a plurality of receiver lines (142). Typically, a seismic source (106) may occupy source locations in turn. At each source location the seismic source (106) may be activated (i.e., fired) at least once to emit seismic waves. The seismic waves emitted by each firing of the seismic source (106) may be detected and recorded by tens of thousands, or hundreds of thousands of receivers (120) each positioned at a distinct receiver location. In some cases, more than one seismic source (106) may be used to efficiently emit seismic waves from every source location. For example, a first seismic source (106) may occupy and emit seismic waves from each source locations along a first source line (140) in turn, while a second seismic source (106) may occupy and emit seismic waves from each source locations along a second source line (140) in turn.

Typically, the spacing of source locations along a source line (140) is smaller than the spacing of receiver locations along a receiver line (142). Further, the spacing of source locations along a source line (140) are less than the spacing between adjacent source lines (140). Similarly, the spacing of receiver locations along a receiver line (142) are typically smaller than the spacing between adjacent receiver lines (142). However, in other cases these relationships between spacings may be different and these typical relationships between spacing should not be interpreted as limiting the scope of the claimed invention.

In a cross-spread geometry each source line (140) may cross each receiver line (142) approximately perpendicularly. In practice, the angle between the source lines (140) and the receiver lines (142) may deviate from 90 degrees due to logistical and access constraints.

In the embodiment depicted in FIG. 1B, one particular shot gather includes traces recorded from five geophones, shown by the five triangles in the vertical rectangle (146). There are six sources present in the horizontal rectangle (144). Thus, there are a total of 30 traces in this particular shot gather since a trace from each of the five geophones is recorded for 6 separate shots. Each intersection of a source line (140) and a receiver line (142) forms the center of a cross spread gather grid (148). Each cross spread gather contains seismic traces from different shot gathers that happen to have a midpoint (between shot and receiver) on the cross spread gather grid (148). The number of traces in a cross spread gather does not have to be the same as in a shot gather. The cross spread gather is a way to reorganize the traces from shot gathers to an ordering that is as if they came from a shot fired over the center of the cross spread gather grid (148) and recorded on the receivers (120) in the cross spread gather grid (148) that surrounds that center point. Cross spread gathers are a useful ordering of seismic data for Kirchhoff migration imaging algorithms.

When acquiring seismic data with orthogonal geometry, a cross spread gather contains traces shot on a single source line (140) and recorded on the corresponding receiver line (142). Source lines (140) and receiver lines (142) may be divided into equal segments in which each segment has the same number of sources and receivers. Segmenting the seismic data in this way creates “average” cross spread gathers at the location of the intersection of source lines (140) and receiver lines (142). Average cross spread gathers improve the signal-to-noise ratio and thereby enhance the quality of a Kirchhoff migration.

Migration methods usually require travel times between points in the subsurface and both receiver (120) and source locations in order to map reflections in traces to their true point of origin in space (or time, in the case of time migration). FIG. 1C shows isochrons of a two-dimensional (“2D”) section through a three-dimensional (“3D”) receiver travel time cube, a source travel time cube, and two-way travel time cube, in accordance with one or more embodiments. Although the term “cube” is frequently used by one or ordinary skill in the art, each 3D travel time cube may have orthogonal dimensions of different sizes and may have different sampling intervals along each dimension. Furthermore, the sampling interval may vary in size at different points along one or more of the dimensions.

The horizontal axis (182) represents position on the surface of the Earth (116). The vertical axis (184) represents depth below the surface of the Earth (116). An example source location (186) and an example receiver location (188) are depicted on the surface of the Earth (116). The solid lines represent isochrons of the receiver travel time cube (190), Tᵣ(x,y,z), and the dotted lines represent isochrons of the source travel time cube (192), Tₛ(x,y,z). The dashed lines represent isochrons of the two-way travel time cube (194), TWT(x,y,z), that may be given by:

$$T W T ( x , y , z ) = {T}_{r} ( x , y , z ) + {T}_{s} ( x , y , z ) \qquad Equation ( 1 )$$

A two-way travel time cube, TWT(x,y,z), for a source location (186) and a receiver (120) location, represents the predicted travel time taken for a seismic wave to propagated from the source location (186) to a position (x,y,z) in the subsurface and back to a receiver location (188). The two-way travel time cube is invariant with respect to switching the receiver location (188) to the source location (186) or the source location (186) to the receiver location (188). The source travel time cube may be determined from a seismic velocity model that specifies the seismic propagation velocity at points within the subsurface by solving an eikonal equation for a particular source location (186). Similarly, the receiver travel time cube may be determined from the seismic velocity model and a receiver location (188). Frequently, both the seismic velocity model and a 3D travel time cube will be defined on a grid of position points representing the subsurface.

Each trace that is migrated needs a travel time table related to a source and receiver to perform migration. The traces in an averaged cross spread gather all use the same travel time table, which is kept in a memory pool, thus reducing computation and memory requirements. The same travel time table is thereby used repeatedly during the migration of the averaged cross-spread gather. If the cross spread gather is not used, migration would require reading two travel time tables from disk files for each trace. Thus, the usage of an averaged cross spread gather maximizes the number of migrated traces for a fixed amount of computational resources.

To convert a seismic data set organized by shot gathers into one organized by cross spread gathers requires sorting the traces and associated headers. Sorting algorithms are broadly categorized into two classes: comparison based sorting and non-comparison sorting. For comparison based sorting algorithms, the data elements are placed in order by comparing each of them with the others. One of the typical comparison based sorting algorithms is known as the merge sort. It has lower time complexity Ω(n log n), where n is the number of elements being sorted.

For the second class, non-comparison sorting algorithms, the data elements are placed in particular order without performing any comparison. Bucket sorting belongs to this family and has a time complexity is of Ω(n+k), where k is the number of buckets.

Parallel computation can improve the efficiency of sorting by splitting the process among several processors. The MPI library and multi-thread algorithms and shared disks may combine the mechanisms of bucket sort and merge sort together to successfully accelerate the process of sorting seismic data on a multi-node/multi-thread computing system.

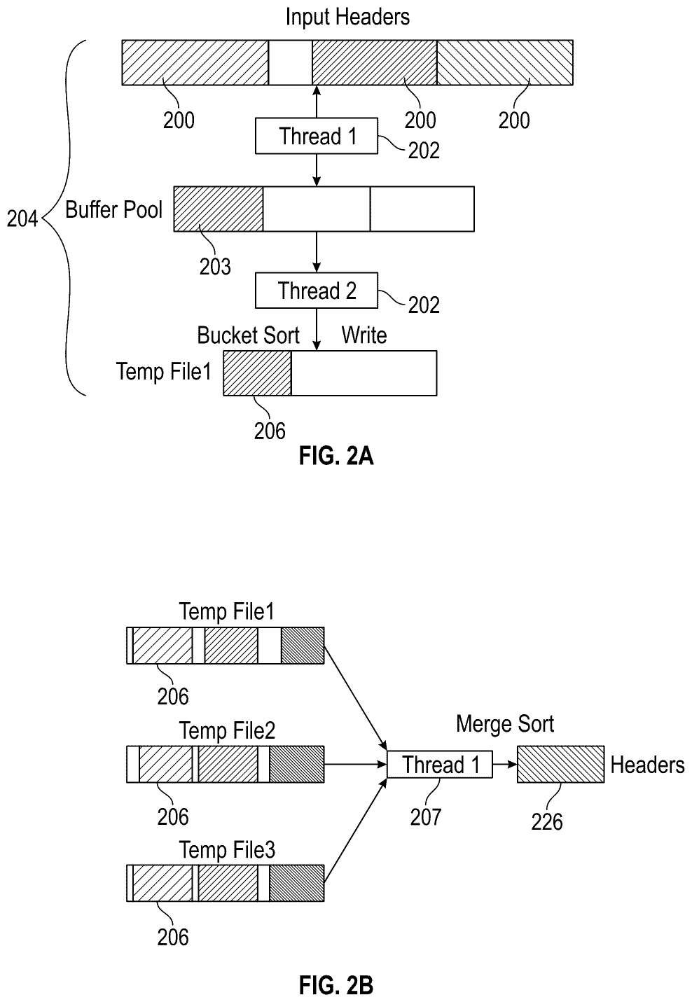

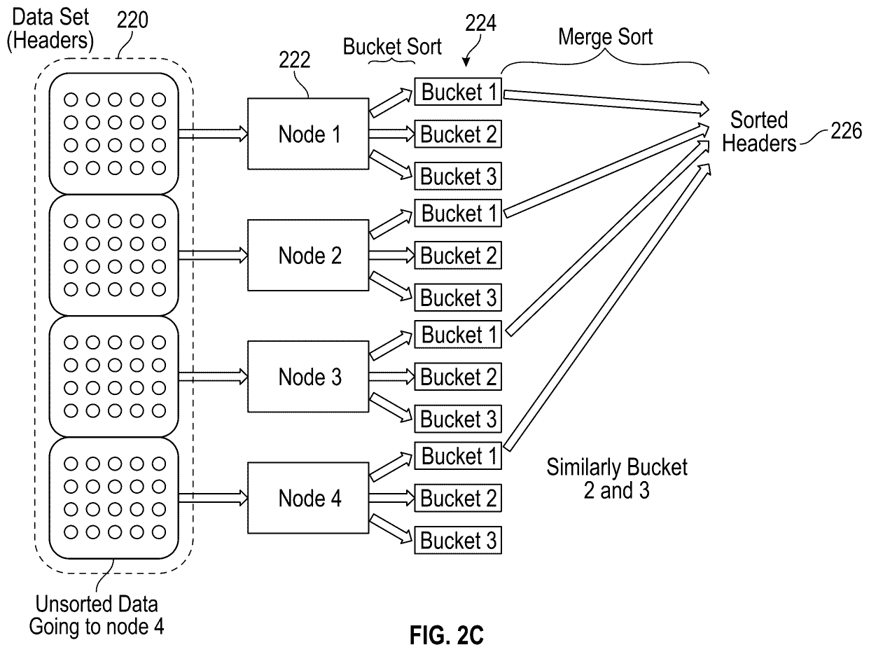

To implement the sorting algorithms on the multi-node and multi-thread computer system one must first build up the relations between the headers (200) and the source lines (140) and receiver lines (142), and then sort the headers (200) according to the intersections of source lines (140) and receiver lines (142). The procedure of the header (200) sorting process are shown in FIG. 2A. Buffer pools (203) are used on each node to store the headers (200) that are then sorted by multiple threads (202) with the bucket sort algorithm as a pipeline (204). The preliminary results are saved as a temp file (206) on the shared disk. In addition, one particular thread (207) is reserved to collect the headers (200) from the temp files (206), apply the merge sort algorithm, and output the final sorted headers (226), as shown in FIG. 2B.

FIG. 2C depicts the entire sorting process of the headers (200). The header data set (220) is first collected in a computer memory buffer. From there, it is partitioned among the collection of nodes (222). Within each node (222), the bucket sort algorithm separates the headers (200) into one of several buckets (224) according to the x and y locations of the associated shots and receivers (120). The buckets are then recombined on a single thread (207) with the merge sort algorithm; this produces the final ordering of the sorted headers (226).

The trace sorting process is carried out after sorting the headers (200). The input seismic traces are fed into buffer pools and then sorted according to the order of the already sorted headers (226). The seismic traces are subsequently saved on a temp file (206) on a shared disk.

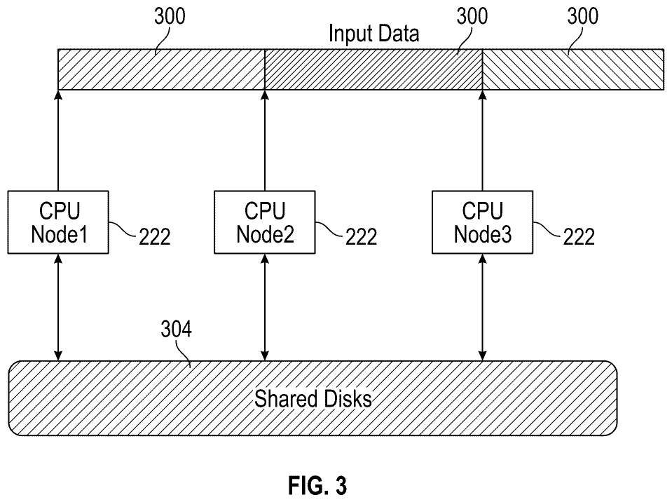

FIG. 3 depicts this process of dividing up an input headers (200) into portions that can fit on individual nodes (222) of the parallel central processing unit (CPU). Each node (222) handles a different part of collection of headers (200) simultaneously. After bucket sorting, the results are then moved to a shared disk (304) in the new ordering to await further processing. This “divide-and-conquer” approach makes the improvement from parallel processing directly proportional to the number of nodes (222) of the computer system.

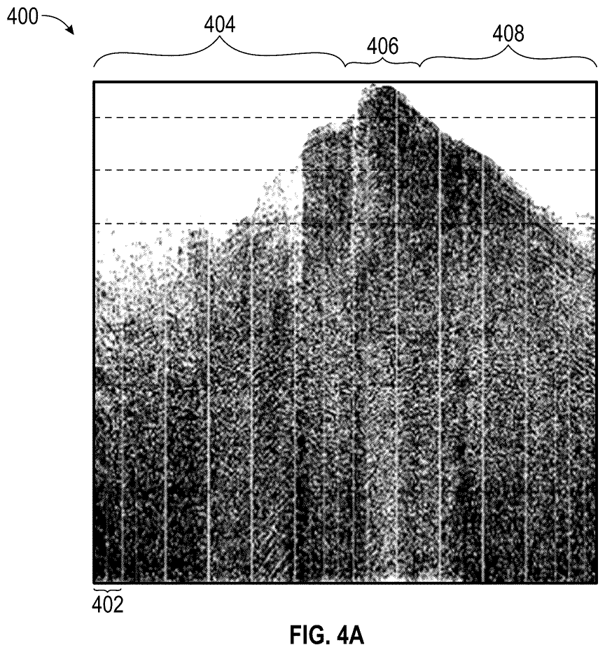

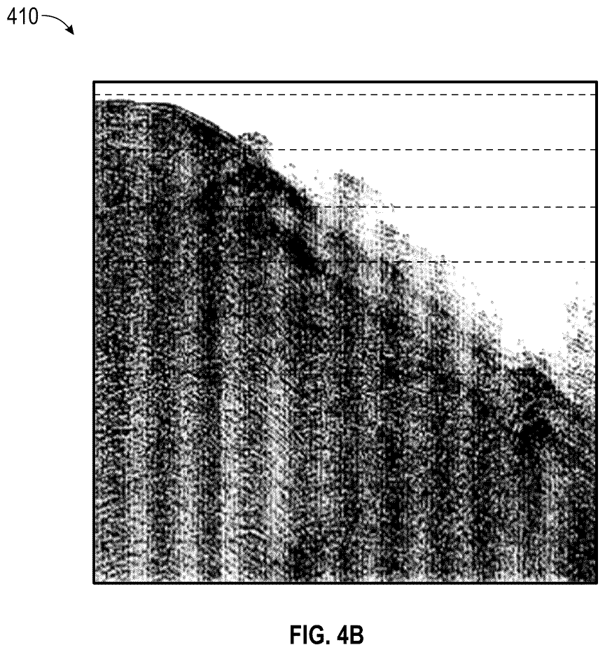

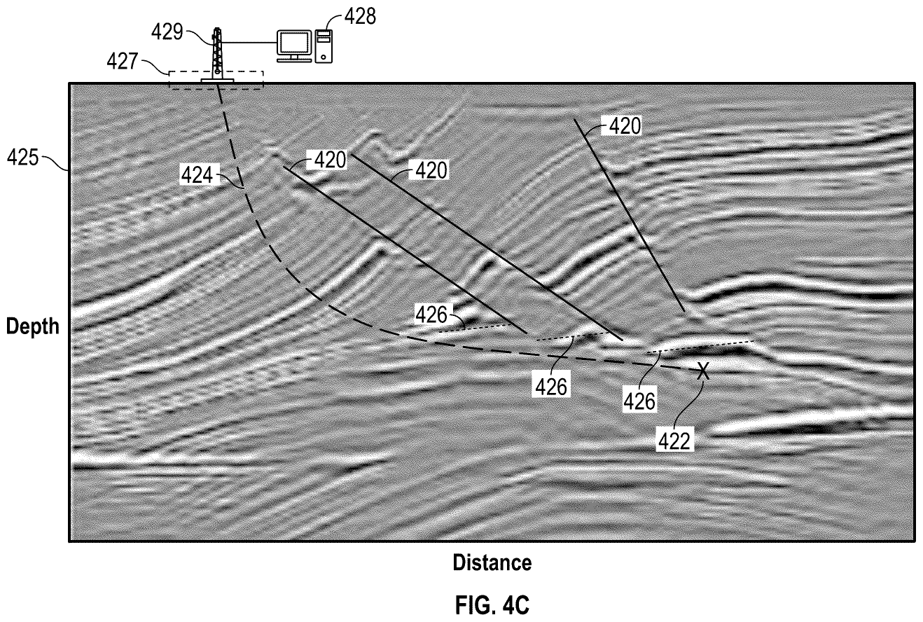

FIG. 4A shows an example of seismic shot gathers (400). Each panel (402) of seismic traces in this image corresponds to the response of a number of receivers (120) to a single shot. The shots are conducted along a line perpendicular to the receiver lines (142). (The portion of the traces before first arrivals has been muted.) Going from left to right, the first shot panels (402) on the left side of the image (404) correspond to where receivers (120) are further from the source. About two thirds of the way to the right (406) of the image are shot panels (402) where the shot is at a location above the receiver line (142). To the far right side of the image (408) are panels (402) where the shots are further away from the receivers (120) again, but this time in the opposite direction on the surface of the Earth (116).

FIG. 4B shows a cross spread gather (410) constructed from the same seismic data in FIG. 4A after cross spread sorting. Shown here is one cross spread gather (410) of seismic traces that lie on the grid of locations surrounding a single cross spread gather (410) center point. No information is retained as to the x-y orientation of the traces on the cross spread gather (410) here. The cross spread gather (410) begins with the trace corresponding to the center point of the cross spread gather grid (148). It then puts the next nearest traces side-by-side in the gather and proceeds from the center point out to the furthest traces on the cross spread gather grid (148). Thus, moving from left to right, we see traces that correspond to midpoints between the center of the cross spread gather grid (148) and receivers (120) that are located further away on the surface of the Earth (116). This explains the generally increasing time to first arrivals in the image, looking from left to right. The azimuthal orientation on the surface of the Earth (116) of the traces relative to the center point of the cross spread gather (410) is not important, only their absolute distance from it.

FIG. 4C shows an example of seismic image (425) processed from seismic data. The imaging algorithm (e.g., Kirchhoff migration) has delineated subsurface features that allow for interpretation of the geology. In this case faults (420) have been identified along with a target zone (422). Impermeable sedimentary cap rock layers (426) have also been interpreted. The borehole path planning system (428), a computer system dedicated to planning a borehole path (424), is used to identify a preferred trajectory from a surface location (427), through the subsurface, to a target zone (422). The target zone (422) may, for example, be a region containing hydrocarbons. The borehole path (424) may be based on one or more seismic images (425), geological knowledge of the area, and other data (i.e., other remote sensing surveys, nearby wells, etc.). In this embodiment, the borehole path (424) will start at a drilling rig (429) on the surface and pass horizontally beneath the faults (420) and into the target zone (422) lying beneath one of the cap rock layers (426). A borehole path (424) that is planned in this way avoids certain geological formations and preferentially passes through others that are less problematic from a drilling perspective. FIG. 4C, therefore, illustrates the utility of seismic images (425) for oil exploration; they allow accurate targeting of a well drilling program, and help avoid well paths that may be impeded by unfavorable formations.

Due to the sorting of the shot gathers by the method of this invention, the process of constructing this seismic image (425) has been greatly sped up, thus minimizing costs and improving the chances of finding hydrocarbons. This allows more opportunities to modify the parameters of the imaging algorithm and reprocess the image, if necessary.

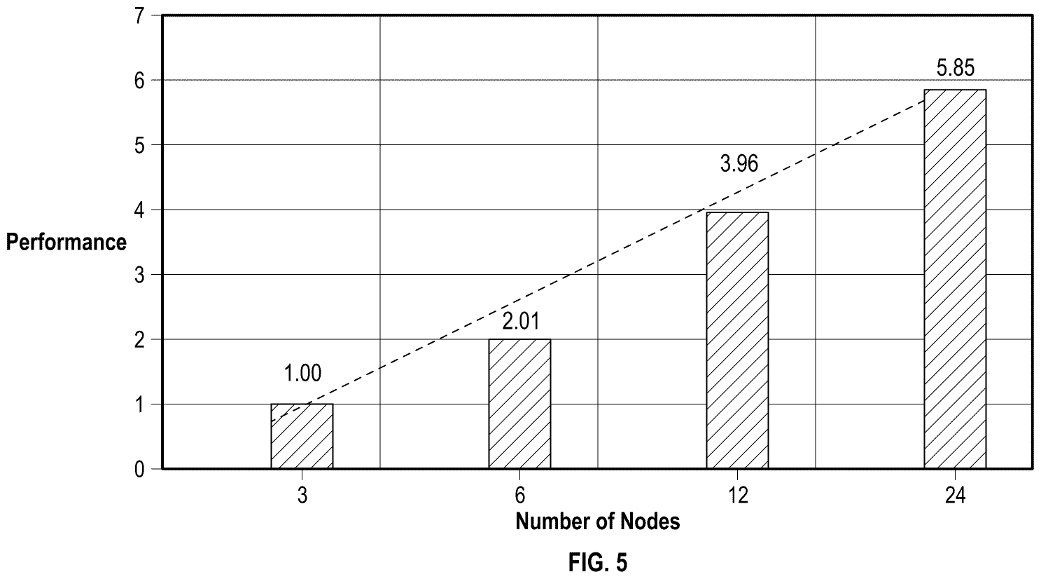

To validate the proposed sorting methods and show their speed increase, numerical experiments were conducted in this embodiment on a seismic dataset of 6 Tb. FIG. 5 shows that the performance of sorting increases as a function of the number of nodes (222). Performance is defined as P=(1/T)/(1/T0)=T0/T, where T0 is the runtime of a 3-node computer and T is the runtime of any other number of nodes (222). The trend line of performance as a function of the number of nodes (222) is linear.

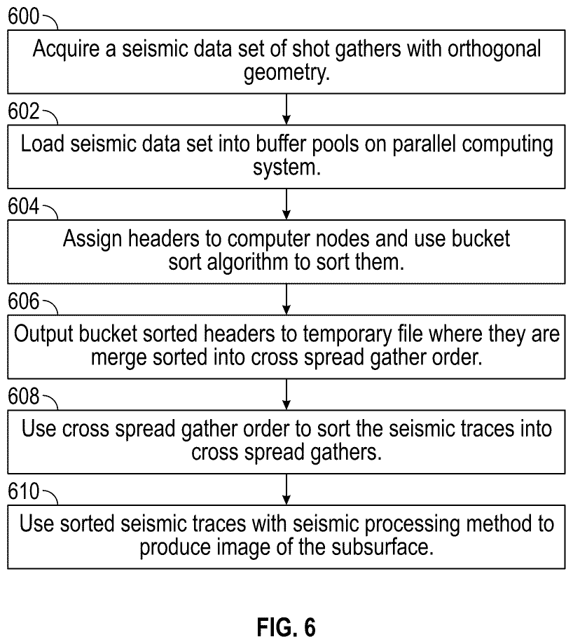

FIG. 6 presents a workflow for the systems and method of parallel cross spread sorting for seismic data. In Step 600, a seismic data set (300) is acquired in the field. The method of this invention assumes an orthogonal grid of source and receiver lines (142). In recording a shot gathers, a seismic source (106) is shot at each point along a source line (140), each time collecting data at all the receivers (120). The data is transported to a processing location where it is loaded onto a computer system with multiple nodes (222) and parallel processing capability, including the MPI library. In Step 602, the shot gathers are loaded into buffers on the computer system to await sorting.

In Step 604, the headers (200) of the seismic traces are extracted from the shot gathers and assigned to different nodes (222) where they are bucket sorted. In this way, the headers (200) are partially reordered. In Step 606, the bucket sorted headers (200) on each node (222) are output to a temporary file where they are merge sorted into cross spread gather order. In Step 608, the seismic traces are put into the same cross spread gather order as the headers (200), thereby creating cross spread gathers. In Step 610, a seismic processing method uses the cross spread gathers (410) of seismic traces to construct an image of the subsurface. Kirchhoff migration is one method that converts cross spread gathers (410) into an image, but the method and systems presented here are not restricted to that particular seismic image processing algorithm.

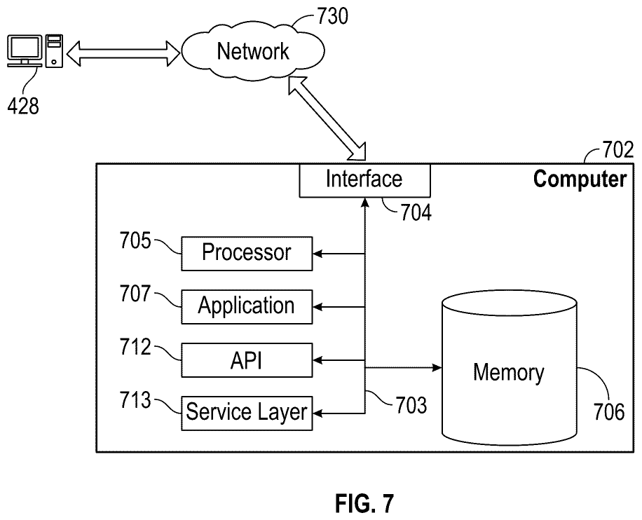

FIG. 7 further depicts a block diagram of a computer system (702) used to provide computational functionalities associated with described algorithms, methods, functions, processes, flows, and procedures as described in this disclosure, according to one or more embodiments. The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

More specifically, the computer system (702) used by this invention has a multi-node, multi-thread processor capable of running multiple threads (202) in parallel. This computer system (702) may run the message passing interface (MPI) library of functions, or any software library with similar functionality. Algorithms run on this parallel computer system (702) may operate by a divide-and-conquer strategy, where data may be subdivided and sent to the different nodes (222) to be processed, and then the results recombined. Buffers may be used on the computer system (702) to hold data before, during, or after processing. Temporary files may be used to hold intermediate results and allow for further manipulation of data. Shared disks (304) may also be used by the computer system (702) as a central location to store data being used simultaneously by several nodes (222).

The method and systems of this invention use buffers, shared disks (304), and temporary files to manipulate large seismic data sets (300). They also use the divide-and-conquer strategy to split the seismic data into chunks that are manageable on individual nodes (222), where sorting algorithms are applied. The sorted data is subsequently recombined. The sorted data represent a cross spread gather (410).

The computer (702) can serve in a role as a client, network component, a server, a database or other persistency, or any other component (or a combination of roles) of a computer system (720) for performing the subject matter described in the instant disclosure. The illustrated computer (702) is communicably coupled with a network (730). In some implementations, one or more components of the computer (702) may be configured to operate within environments, including cloud-computing-based, local, global, or other environment (or a combination of environments).

A borehole path planning system (428) may be another computer (702) connected to a computer system (720). The borehole path planning system (428) may be dedicated solely to planning a borehole path (424) in the subsurface or may be implemented as part of a combined system such as computer system (720). It may be connected to the computer system (720) through the network (730).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over the network (730) from a client application (for example, executing on another computer (702) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 4, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 4, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) can be a database storing data consistent with this disclosure. Although illustrated as a single memory (706) in FIG. 4, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

Although only a few example embodiments have been described in detail above, those skilled in the art will readily appreciate that many modifications are possible in the example embodiments without materially departing from this invention.

What is claimed:

1. A method comprising:
obtaining a seismic dataset comprising a plurality of shot gathers;
dividing headers from the plurality of shot gathers among a plurality of computer nodes;
sorting the headers separately on each of the plurality of computer nodes;
saving the sorted headers from the plurality of computer nodes to a temporary file;
sorting the sorted headers saved to the temporary file into a cross spread gather ordering;
sorting seismic traces according to the cross spread gather ordering to create cross spread gathers; and
applying a seismic imaging algorithm to the cross spread gathers to create a seismic image.

2. The method of claim 1, wherein sorting the headers on the plurality of computer nodes comprises using a bucket sort algorithm.

3. The method of claim 1, wherein sorting the headers on the temporary file comprises using a merge sort algorithm.

4. The method of claim 1, further comprising storing the headers and the seismic traces on the plurality of computer nodes using buffer pools.

5. The method of claim 1, wherein the seismic shot gathers are acquired with an orthogonal geometry.

6. The method of claim 1, wherein the cross spread gathers are averaged according to a segmentation of the seismic dataset.

7. The method of claim 1, wherein the seismic imaging algorithm comprises Kirchhoff migration.

8. The method of claim 1, further comprising:
identifying a target zone using the seismic image; and
planning a borehole path from a surface location to the target zone using the seismic image.

9. The method of claim 8, further comprising drilling a borehole from the surface location to the target zone according to the borehole path.

10. A non-transitory computer-readable memory comprising computer-executable instructions stored thereon that, when executed on a processor, cause the processor to perform steps comprising:
obtaining a seismic dataset comprising a plurality of shot gathers;
dividing headers from the plurality of shot gathers among a plurality of computer nodes;
sorting the headers separately on each of the plurality of computer nodes;
saving the sorted headers from the plurality of computer nodes to a temporary file;
sorting the sorted headers saved to the temporary file into a cross spread gather ordering;
sorting seismic traces according to the cross spread gather ordering to create cross spread gathers; and
applying a seismic imaging algorithm to the cross spread gathers to create a seismic image.

11. The non-transitory computer-readable memory of claim 10, wherein sorting the headers on the plurality of computer nodes comprises using a bucket sort algorithm.

12. The non-transitory computer-readable memory of claim 10, wherein sorting the headers on the temporary file comprises using a merge sort algorithm.

13. The non-transitory computer-readable memory of claim 10, wherein sorting the seismic traces on the temporary file comprises using a merge sort algorithm.

14. The non-transitory computer-readable memory of claim 10, wherein the steps further comprise storing the headers and the seismic traces on the plurality of computer nodes using buffer pools.

15. The non-transitory computer-readable memory of claim 10, wherein the cross spread gathers are averaged according to a segmentation of the seismic dataset.

16. The non-transitory computer-readable memory of claim 10, wherein the seismic imaging algorithm comprises Kirchhoff migration.

17. A system comprising:
a parallel processing computer system configured to:
divide headers from a plurality of shot gathers among a plurality of computer nodes,
sort the headers separately on each of the plurality of computer nodes;
save the sorted headers from the plurality of computer nodes to a temporary file,
sort the sorted headers saved to the temporary file into a cross spread gather ordering,
sort seismic traces according to the cross spread gather ordering to create cross spread gathers, and
apply a seismic imaging algorithm to the cross spread gathers to create a seismic image;
a borehole path planning system configured to plan a borehole path from a surface location to a target zone based on the seismic image; and
a drilling rig configured to drill a borehole from the surface location to the target zone along the borehole path.

18. The system of claim 17, wherein the parallel processing computer system is further configured to store the headers and the seismic traces on the plurality of computer nodes using buffer pools.

19. The system of claim 17, wherein the seismic imaging algorithm comprises Kirchhoff migration.

20. The system of claim 17, wherein the parallel processing computer system is further configured to identify the target zone.
